(19) United States
(12) Patent Application Publication
(10) Pub. No.: US 2011/0167656 A1
(43) Pub. Date: Jul. 14, 2011

(54) LASER MODULE CO-AXIS ADJUSTMENT STRUCTURE

(76) Inventor: Hsien-Jung HUANG, Taipei City (TW)

(21) Appl. No.: 12/751,465

(22) Filed: Mar. 31, 2010

(30) Foreign Application Priority Data
Jan. 13, 2010 (TW) 099200671

(51) Int. Cl. G01B 11/00

(52) U.S. Cl. 33/286

(57) ABSTRACT

A laser module co-axis adjustment structure includes a laser module that includes an optical module and a laser diode housed inside a hollow casing and a circuit board for controlling the laser diode to emit a laser beam through the optical module, and an eccentric sleeve, which is rotatable relative to the casing through 360-degrees and has an eccentrically disposed inside sloping surface stopped against the periphery of the hollow casing of the laser module for enabling the eccentric sleeve to be rotated relative to the laser module to adjust the mechanical axis of the eccentric sleeve into alignment with the optical axis of the optical module of the laser module. The eccentric sleeve and the hollow casing may be affixed with an adhesive after calibration of the alignment.

This application claims the priority benefit of Taiwan patent application number 099200671, filed on Jan. 13, 2010.

### BACKGROUND OF THE INVENTION

1. Field of the Invention

The present invention relates to laser module technology and more particularly, to a laser module co-axis adjustment structure, which allows calibration of the alignment of the optical axis by means of rotating an eccentric sleeve through 360-degrees relative to the laser module.

2. Description of the Related Art

Visible light (red or green) laser modules are intensively used in pointing devices, aiming device, level tools, line laser markers. These conventional laser module designs have appeared on the market for years. However, few manufacturers make improvement on the quality of the spot or line of light generated. Because regular laser modules are small-sized products, it is difficult to adjust the laser diode and the optical lens system into perfect alignment. If the laser diode and the optical lens system are not perfectly aligned, the pattern of the light spot of the generated laser beam will be incomplete, and the optical axis will not be concentrically aligned with the mechanical axis. These conventional laser modules cannot satisfy consumers' strict quality requirements. Using these conventional laser modules does not provide satisfactory effects (the problem will become worse if it is used for a long distance application), lowering the added value.

Following fast development of optical technology, many measuring instruments (for example, leveling tools) need to use green light for indication. In a green laser module, copper or aluminum members are used to hold optical components in place. The use of these copper or aluminum members complicates the assembly process. During installation, it is difficult to keep the optical axis in perfect alignment with the mechanical axis.

Early red laser module designs commonly have a simple structure. FIGS. 7 and 8 show a conventional laser diode co-axis adjustment structure, which was invented by the present inventor. According to this design, a lens C is mounted in a lens holder B, and then the outer thread B1 of the lens holder B is threaded into an inner thread A1 in one end of a barrel A, and then a circuit board F carrying a laser diode E is mounted in a laser diode holder D that is threaded into the inner thread A1 in the other end of the barrel A with a clearance left between the outer thread D2 of the laser diode holder D and the inner thread A1 of the barrel A, and then four tightening-up screws A3 are respectively threaded into equiangularly spaced radial screw holes A2 of the barrel A and stopped against a bearing wall portion D1 of the laser diode holder D to lock the laser diode holder D. By means of adjusting the X-axis and Y-axis tightening-up screws A3 to move the laser diode holder D in the barrel A, the axis of the laser diode E is adjusted into perfect alignment with the axis of the lens C. According to the aforesaid design, the X-axis and Y-axis tightening-up screws A3 are adjustable to calibrate the positioning of the laser diode holder D in the barrel A. By means of using one of the two X-axis or Y-axis tightening-up screws A3 for positioning and the other X-axis or Y-axis tightening-up screw A3 to hold down the laser diode holder D, the laser diode holder D is fine-adjusted in X-axis direction or Y-axis direction. However, because the barrel A is a small-sized member, tapping the screw holes A2 on the barrel A may damage the structure or lower the strength of the barrel A. To avoid this problem, the barrel A must have a certain wall thickness. However, increasing the wall thickness of the barrel

A will relatively increase the dimension of the barrel A. Therefore, this design of laser diode co-axis adjustment structure does not meet small size and high precision requirements.

### SUMMARY OF THE INVENTION

The present invention has been accomplished under the circumstances in view. It is therefore the main object of the present invention to provide a laser module co-axis adjustment structure, which has small size and high precision characteristics. It is another object of the present invention to provide a laser module co-axis adjustment structure, which facilitates calibration of the alignment of the optical axis.

To achieve these and other objects of the present invention, a laser module co-axis adjustment structure comprises a laser module and an eccentric sleeve. The laser module comprises a hollow casing, an optical module mounted inside the hollow casing, a circuit board, a laser diode electrically soldered to the circuit board and controlled by the circuit board to emit a laser beam through the optical module. The eccentric sleeve is movably sleeved onto the hollow casing of the laser module and rotatable relative to the hollow casing through 360-degrees. The eccentric sleeve has an eccentrically disposed inside sloping surface stopped against the periphery of the hollow casing of the laser module for enabling the eccentric sleeve to be rotated relative to the laser module to adjust the mechanical axis of the eccentric sleeve into alignment with the optical axis of the optical module of the laser module.

Further, the hollow casing of the laser module has an outer thread. Further, the eccentric sleeve has an inner thread threaded onto the outer thread of the hollow casing of the laser module, facilitating stable and accurate rotation of the eccentric sleeve relative to the laser module during calibration.

Further, the laser module co-axis adjustment structure can be installed in a front barrel of a laser marker body, constituting a laser pointer. Further, a cylindrical lens can be installed in the front barrel of the laser marker body in front of the eccentric sleeve, thereby constituting a line laser marker.

### BRIEF DESCRIPTION OF THE DRAWINGS

FIG. 1 is an oblique elevation of a laser module co-axis adjustment structure in accordance with the present invention.

FIG. 2 is an exploded view of the laser module co-axis adjustment structure in accordance with the present invention.

FIG. 3 is a schematic sectional side view of the present invention before adjustment.

FIG. 4 corresponds to FIG. 3, showing the angular misalignment of the optical axis calibrated.

FIG. 5 is a schematic sectional side view of an alternate form of the present invention, showing the eccentric sleeve and the hollow cylindrical casing of the laser module fastened together by a screw joint.

FIG. 6 is a schematic applied view of the present invention, showing the laser module co-axis adjustment structure used in a laser pointer.

FIG. 7 is an exploded view of a laser module according to the prior art.

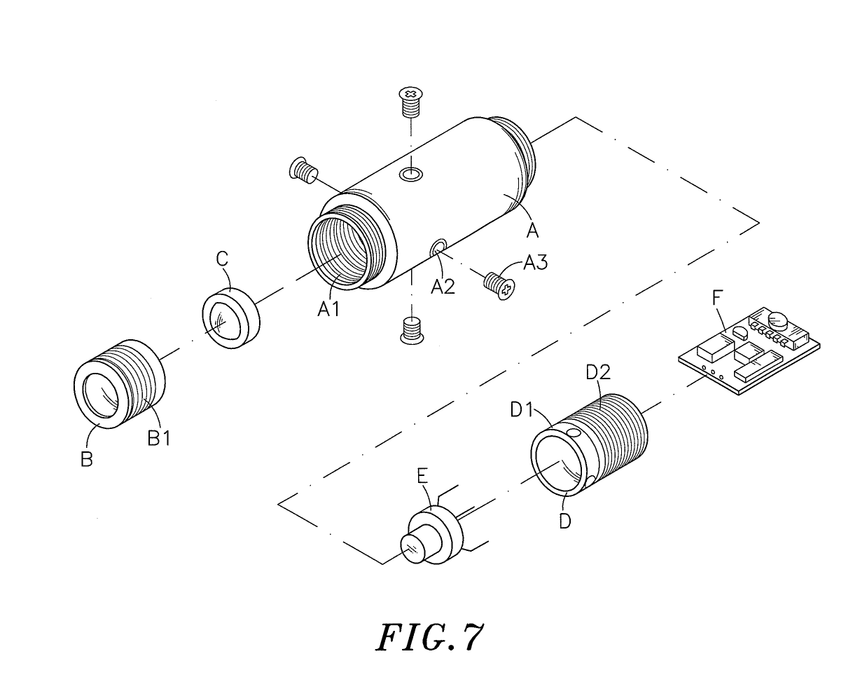

FIG. 8 is a sectional assembly view in an enlarged scale of the prior art laser module.

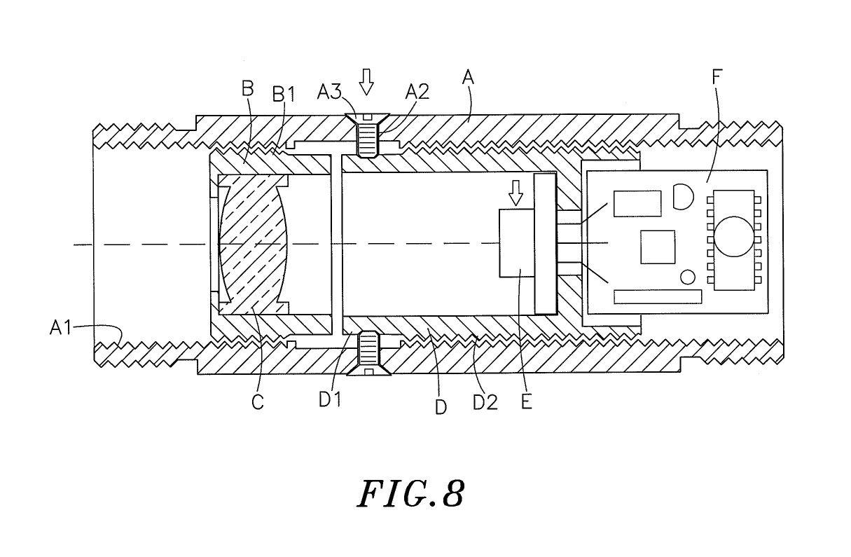

### DETAILED DESCRIPTION OF THE PREFERRED EMBODIMENT

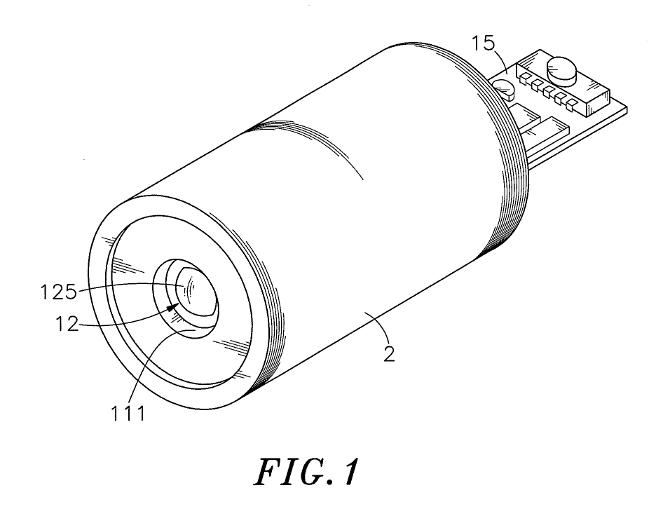

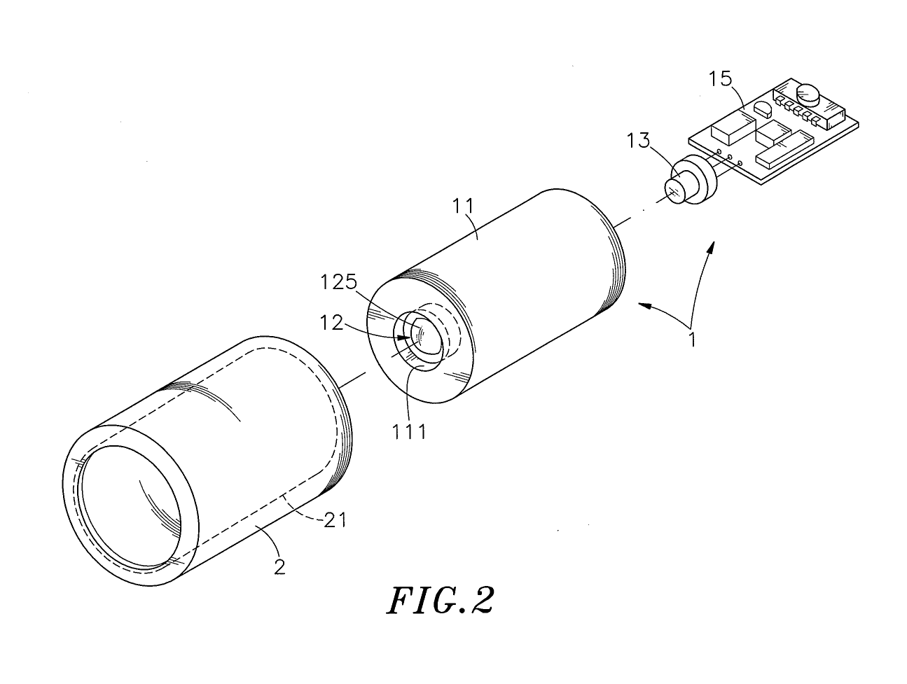

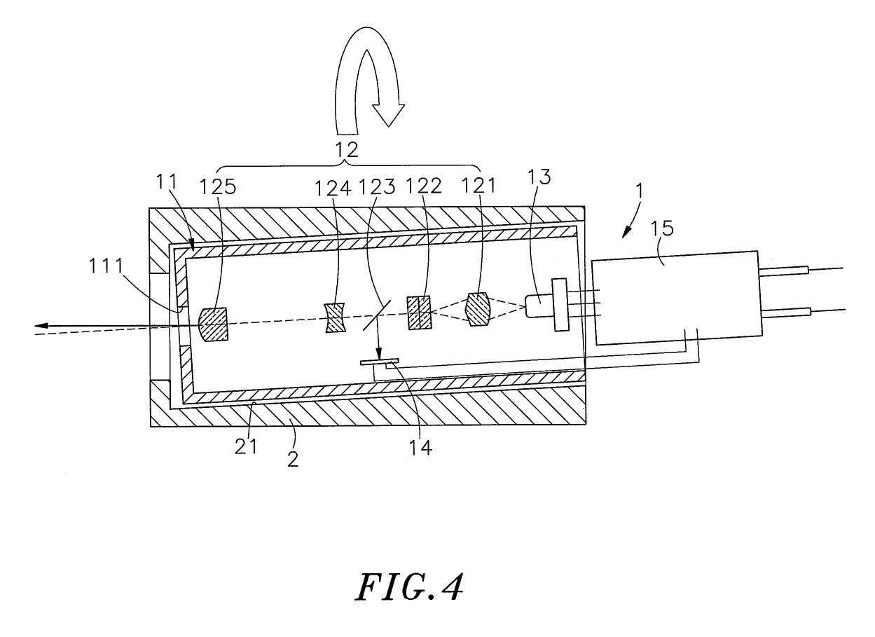

Referring to FIGS. 1-4, a laser module co-axis adjustment structure in accordance with the present invention is shown comprising a laser module 1 and an eccentric sleeve 2.

The laser module 1 comprises a hollow cylindrical casing 11, an optical module 12, a laser diode 13, a photovoltaic diode 14 and a circuit board 15. The hollow cylindrical casing 11 houses the optical module 12, the laser diode 13 and the photovoltaic diode 14.

The laser diode 13 and the photovoltaic diode 14 are electrically soldered to the circuit board 15 that is disposed at the rear side of the hollow cylindrical casing 11. The optical module 12 is mounted inside the hollow cylindrical casing 11 in axial alignment with a front projection hole 111 of the hollow cylindrical casing 11. The laser diode 13 operates in the wavelength within 800-820 nm. Further, the optical module 12 comprises a focus lens 121, a crystal component set 122, a beam splitter 123, a bi-concave lens 124 and a lens 125. When the laser diode 13 emits a laser beam through the optical module 12 to produce 520-540 nm green light, the beam splitter 123 projects a part of the light beam onto the photovoltaic diode 14 during laser modulation, causing the control circuit at the circuit board 15 to control the output of the laser diode 13 subject to the feedback signal from the photovoltaic diode 14. With respect to the technique how the laser beam emitted from the laser module 13 is converted into green light (532 nm) by the optical module 12 is not within the scope of the present invention, therefore no further detailed description is this regard is necessary.

The eccentric sleeve 2 is made from a metal material, for example, copper or aluminum, and movably sleeved onto the hollow cylindrical casing 11 of the laser module 1 for fine adjustment, having an inside sloping surface 21 that is stopped against the periphery of the hollow cylindrical casing 11 for enabling the eccentric sleeve 2 to be rotated relative to the hollow cylindrical casing 11.

During installation of the present invention, the optical module 12, the laser diode 13 and the photovoltaic diode 14 are installed in the hollow cylindrical casing 11, and then the laser diode 13 and the photovoltaic diode 14 are electrically soldered to the circuit board 15, and then eccentric sleeve 2 is sleeved onto the hollow cylindrical casing 11 of the assembled laser module 1. When the mechanical axis of the laser module 1 is in concentricity with the mechanical axis of the eccentric sleeve 2, the laser module 1 and the eccentric sleeve 2 are locked, thereby finishing the assembly.

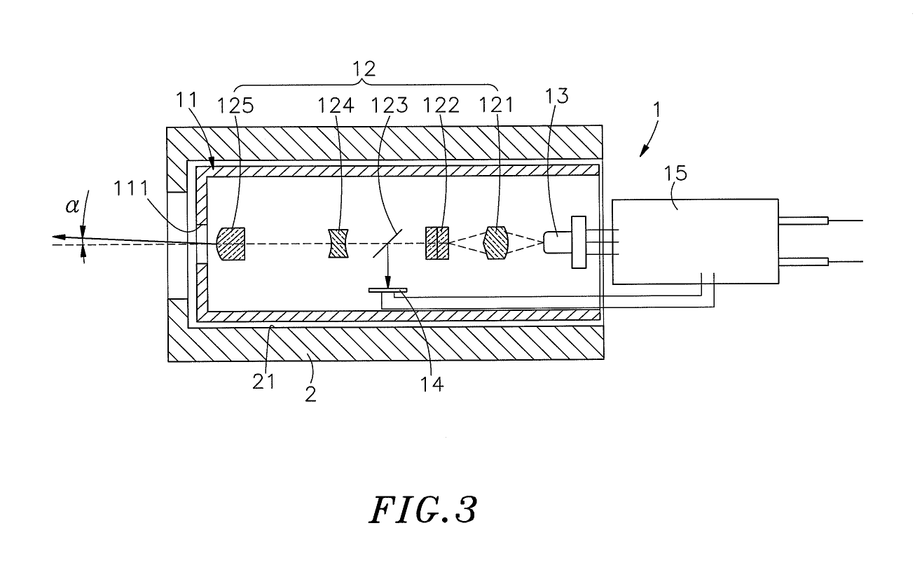

Because the laser module 1 is composed of a plurality of components, it is difficult to keep the optical axis of laser beam emitted from the laser diode 13 through the optical module 12 in concentricity with the mechanical axis of the hollow cylindrical casing 11. Further, because the laser module 1 is composed of a plurality of small-sized components, the control of the positioning of the components during the assembly process is complicated. Cumulative displacements of the components may occur. When this problem occurs, the center of the optical module 12 and the center of the laser diode 13 will not be kept on the same axis, resulting in an angular misalignment of the optical axis at angle “a” (see FIG. 3). The invention allows calibration of the optical axis. If the mechanical axis of the laser module 1 is not in concentricity with the mechanical axis of the eccentric sleeve 2, the eccentric sleeve 2 can be rotated through 360° relative to the laser module 1 to move the inside sloping surface 21 over the periphery of the hollow cylindrical casing 11 of the laser module 1, causing the mechanical axis of the eccentric sleeve 2 to be fine-adjusted into accurate alignment with the optical axis of the optical module 12 of the laser module 1. When the mechanical axis of the laser module 1 is in concentricity with the mechanical axis of the eccentric sleeve 2 after adjustment, the laser module 1 and the eccentric sleeve 2 are tightly fitted in position. An adhesive or glue may be applied to bond the laser module 1 and the eccentric sleeve 2 together. Thus, the invention facilitates alignment between the optical axis of the optical module 12 of the laser module 1 with the mechanical axis of the eccentric sleeve 2, eliminating the problems of thick wall thickness and big device size derived from conventional screw adjustment designs. Therefore, the invention has the advantages of simple structure, less number of components, ease of calibration, low material consumption and low manufacturing cost. Further, the light spot pattern of the laser beam emitted from the laser diode 13 through the optical module 12 is complete.

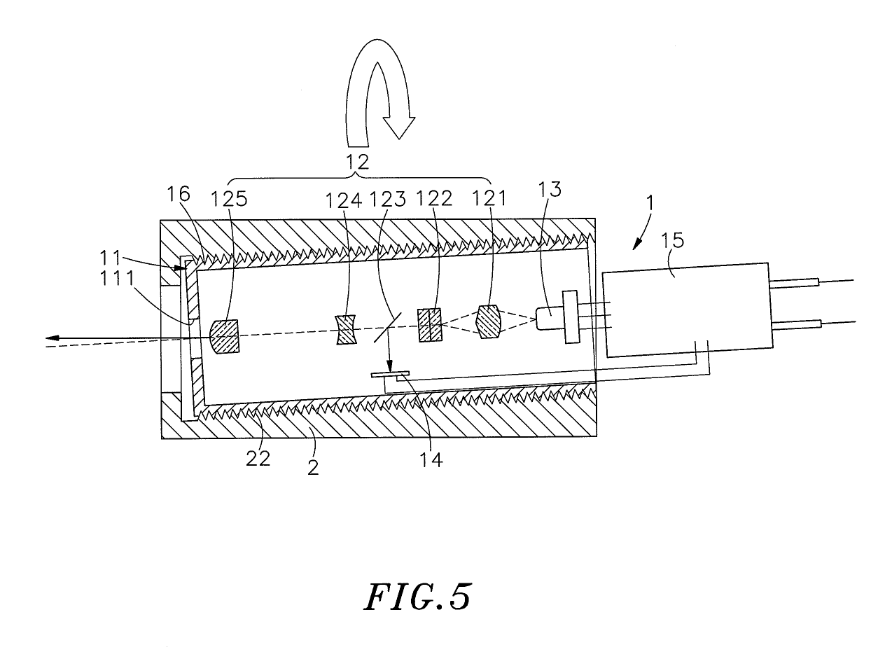

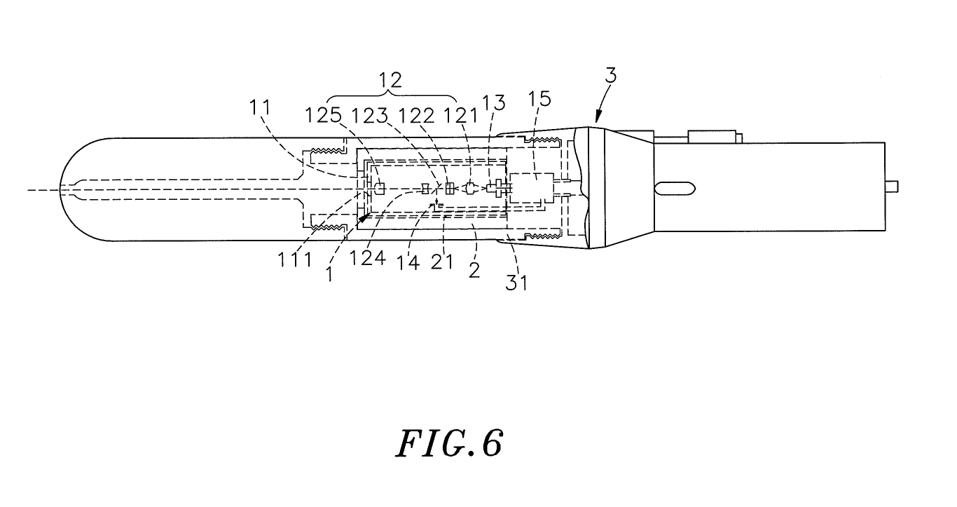

FIGS. 1-4 simply explain one embodiment of the present invention. This embodiment is not a limitation. In an alternate form of the present invention as shown in FIG. 5, the hollow cylindrical casing 11 of the laser module 1 has an outer thread 16, and the eccentric sleeve 2 has an inner thread 22 meshed with the outer thread 16. This design facilitates stable rotation of the eccentric sleeve 2 relative to the laser module 1 during calibration. Further, the invention can also be used to make a laser pointer. As shown in FIG. 6, the laser module co-axis adjustment structure of the assembly of the laser module 1 and the eccentric sleeve 2 can be mounted in the front barrel 31 of a laser pointer body 3, constituting a laser pointer. Further, the laser module 1 is preferably a green laser module. However, this is not a limitation. By means of positioning a cylindrical mirror (not shown) in the front barrel 31 of the laser pointer body 3 in front of the eccentric sleeve 2, a line laser marker is constituted. When the laser diode 13 is energized to emit a laser beam through the cylindrical lens, the cylindrical lens refracts the laser beam for marking a line of light on a workpiece for guiding a cutting tool to cut the workpiece.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A laser module co-axis adjustment structure, comprising:
a laser module, said laser module comprising a hollow casing, an optical module mounted inside said hollow casing, a circuit board, a laser diode electrically soldered to said circuit board and controlled by said circuit board to emit a laser beam through said optical module; and
an eccentric sleeve movably sleeved onto said hollow casing of said laser module and rotatable relative to said hollow casing through 360-degrees, said eccentric sleeve having an eccentrically disposed inside sloping surface stopped against the periphery of said hollow casing of said laser module for enabling said eccentric sleeve to be rotated relative to said laser module to adjust the mechanical axis of said eccentric sleeve into alignment with the optical axis of said optical module of said laser module.

2. The laser module co-axis adjustment structure as claimed in claim 1, wherein said laser module further comprises a photovoltaic diode mounted inside said hollow casing and electrically soldered to said circuit board adapted for providing a feedback signal to said circuit board when said laser diode is controlled by said circuit board to emit a laser beam.

3. The laser module co-axis adjustment structure as claimed in claim 1, wherein said optical module is comprised of a focus lens, a crystal component set, a beam splitter, a bi-concave lens and a lens.

4. The laser module co-axis adjustment structure as claimed in claim 1, wherein said hollow casing has a front projection hole located on a front end thereof in axial alignment with said optical module.

5. The laser module co-axis adjustment structure as claimed in claim 1, wherein said hollow casing of said laser module has an outer thread; said eccentric sleeve has an inner thread threaded onto said outer thread of said hollow casing of said laser module.
